(19) United States
(12) Patent Application Publication
(10) Pub. No.: US 2014/0301086 A1
(43) Pub. Date: Oct. 9, 2014

(54) OPTICAL SHEET AND LIGHTING DEVICE INCLUDING THE SAME

(71) Applicant: LG INNOTEK CO., LTD., Jung-gu, Seoul (KR)

(72) Inventors: Beom Sun Hong, Seoul (KR); Dong Hyun Lee, Seoul (KR); Dong Mug Seong, Seoul (KR); Jun Phill Eom, Seoul (KR)

(73) Assignee: LG INNOTEK CO., LTD., Seoul (KR)

(21) Appl. No.: 14/355,359

(22) PCT Filed: Oct. 31, 2012
(86) PCT No.: PCT/KR2012/009057

§ 371 Date: Apr. 30, 2014

(30) Foreign Application Priority Data
Oct. 31, 2011 (KR) 10-2011-0112289

(51) Int. Cl. F21V 5/02

(52) U.S. Cl. CPC F21V 5/02
USPC 362/311.01; 362/339

(57) ABSTRACT

Provided are an optical sheet used for a lighting device, and the lighting device, the optical sheet comprising: a base plate; and an optical plate including a plurality of micro pattern units formed on the base plate, wherein the respective micro pattern units have any one shape of a quadrangular pyramid shape, a conical shape, and a polypyramid shape, wherein an edge angle formed between the base plate and a side surface of the micro pattern units is determined within a range of 15 degrees to 45 degrees.

### TECHNICAL FIELD

The present invention relates to an optical sheet, more specifically, to an optical sheet and a lighting device including the optical sheet, which can reduce a UGR (Unified Glare Rating).

### BACKGROUND ART

Generally, lighting is an activity or a function to brighten a certain place using various kinds of light sources with a particular purpose. The lighting is mostly used to make an environment brighter in the night or in the dark.

FIG. 1 is a cross-sectional view illustrating a flat lighting device according to an exemplary embodiment of a conventional art. Referring to FIG. 1, the lighting device according to the exemplary embodiment of the conventional art includes a light source 10 and a louver or a reflecting shade 20. an incandescent light bulb, an LED, a CCFL, or the like may be used for the light source 10. Referring to FIG. 1, light at angles denoted with dotted lines causes visually discomfort to a person when it is transferred to the person. Such a lighting device may reduce a UGR mechanically, but cannot be aesthetic or perfect flat lighting.

FIG. 2 is a cross-sectional view illustrating a flat lighting device according to another exemplary embodiment of a conventional art. Referring to FIG. 2, a lighting device 30 includes the light source 10 and a diffusion plate 40 for diffusing light emitted from the light source 10. The light emitted from the light source 10 is discharged to the outside through the diffusion plate 40. The diffusion plate 40 is used for reducing hot spots of the light source and emitting uniformly light. Although the diffusion plate 40 is used, as illustrated in FIG. 2, the light at the angles denoted with the dotted lines still gives discomfort to the eyes of a person. That is, since the diffusion plate 40 scatters the light up to a direction in which a high UGR is generated, glare occurs, thereby making a user's eyes tired. Thus, so such a diffusion plate fails to meet the standard of an indoor flat lighting device.

Accordingly, it is important to reduce the glare to the eyes in indoor flat lighting. The degree of discomfort due to the glare to the eyes is represented using a constant called a UGR (Unified Glare Rating). That is, the UGR is a value calculated by quantifying the degree of discomfort giving to the user of a lighting device.

The UGR is calculated by the value of a luminous flux emitted at the angle between 65 degrees to 90 degrees when a direction facing a bottom surface from a ceiling provided with a lighting device is set to 0 degrees and a direction parallel to the ceiling is set to 90 deg. That is, when the luminous flux at 65 degrees to 90 degrees reduces, glare reduces. In Europe and USA, to be used as an indoor lighting device, the UGR should have a value of less than 19.

### DISCLOSURE OF INVENTION

### Technical Problem

Like this, most currently used indoor flat lighting devices reduce a light spreading angle into a broad range which affects the UGR, by using a reflecting shade or a louver, or burying the whole lighting device. According to the conventional art, even though the diffusion plate is used, the influence of hot spots may be reduced, but the lighting device according to the conventional art is problematic in that it is still not conformable with the UGR standard of less than 19.

### Solution to Problem

Accordingly, the present invention has been made keeping in mind the above problems occurring in the related art. An aspect of the present invention provides an optical sheet and a lighting device including the optical sheet, which can reduce a UGR (Unified Glare Rating).

According to an aspect of the present invention, there is provided an optical sheet for a lighting device including: a base plate; and a plurality of micro pattern units formed on the base plate, wherein the respective micro pattern units have any one shape of a quadrangular pyramid shape, a conical shape, and a polypyramid shape, wherein an edge angle formed between the base plate and a side surface of the micro pattern units is determined within a range of 15 degrees to 45 degrees.

The edge angle may be determined within a range of 30 degrees to 40 degrees. The base plate may be formed of polycarbonate (PC) or polymethyl methacrylate (PMMA).

The plurality of micro pattern units may be formed on the base plate using resin.

According to another aspect of the present invention, there is provided a lighting device, comprising: a light source unit for emitting light; a diffusion plate for diffusing and irradiating the light incident from the light source unit; and an optical sheet including a base plate, and a plurality of micro pattern units formed on the base plate, wherein the respective micro pattern units have any one shape of a quadrangular pyramid shape, a conical shape, and a polypyramid shape.

The lighting device may further comprise a frame unit for housing the light source unit, the diffusion plate and the optical sheet.

The diffusion plate may include a resin layer and beads embedded in the resin layer.

### Advantageous Effects of Invention

Like this, the present invention provides the optical plate for lighting which can adjust the UGR and efficiency (i.e. a total luminous flux) by adjusting a shape of the micro pattern units. That is, the present invention can optimize the UGR and efficiency by changing the edge angle of the micro pattern units.

### BRIEF DESCRIPTION OF DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a cross-sectional view showing a flat lighting device according to an exemplary embodiment of a conventional art.

FIG. 2 is a cross-sectional view showing a flat lighting device according to another exemplary embodiment of a conventional art.

FIG. 3 is a dismantled perspective view showing a lighting device including an optical sheet according to an exemplary embodiment of the present invention.

FIG. 4 is a view showing an enlarged diffusion plate and optical plate of the flat lighting device of FIG. 3.

FIG. 5 and FIG. 6 are views showing the shapes of micro pattern units of an optical plate according to other exemplary embodiments of the present invention.

FIG. 7 through FIG. 9 illustrate the simulation results of light paths in the case where the micro pattern units have a quadrangular pyramid shape.

FIG. 10 shows the distribution of light of the micro pattern units having the quadrangular pyramid shape.

FIG. 11 through FIG. 13 are graphs showing optical properties based on the values of an edge angle of the micro pattern units having the quadrangular pyramid shape.

FIG. 14 shows a relation between the edge angle of a quadrangular pyramid, a luminous flux, and a UGR as a table.

FIG. 15 shows the distribution of light of micro pattern units having a conical shape.

FIG. 16 and FIG. 17 are graphs showing optical properties based on the values of an edge angle of the micro pattern units having the conical shape.

FIG. 18 shows a relation between the edge angle of a cone, a luminous flux, and a UGR as a table.

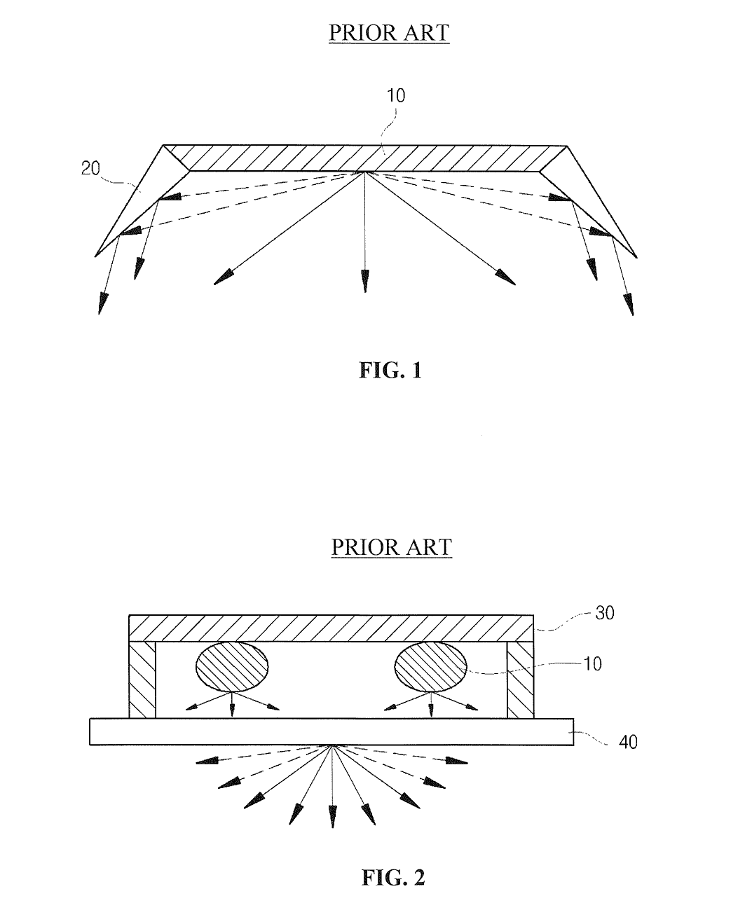

### MODE FOR THE INVENTION

Hereinafter, preferred embodiments of the present invention will be described in detail with reference to the accompanying drawings. In the following description, it is to be noted that, when the functions of conventional elements and the detailed description of elements related with the present invention may make the gist of the present invention unclear, a detailed description of those elements will be omitted.

Further, it should be understood that the shape and size of the elements shown in the drawings may be exaggeratedly drawn to provide an easily understood description of the structure of the present invention rather than reflecting the actual sizes of the corresponding elements.

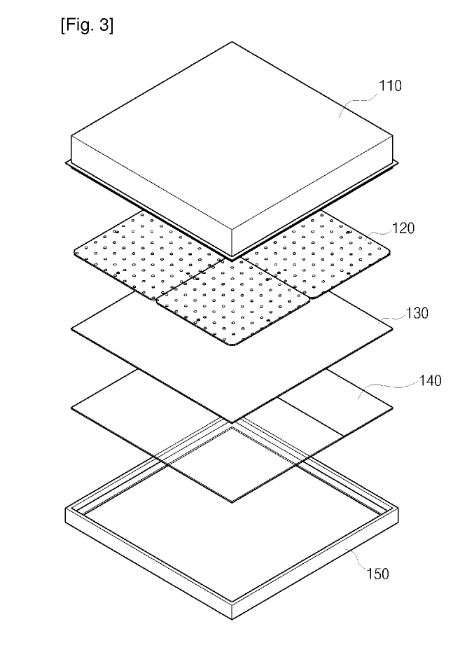

FIG. 3 is a dismantled perspective view showing a lighting device including an optical sheet according to an exemplary embodiment of the present invention.

Referring to FIG. 3, the lighting device according to an exemplary embodiment of the present invention is a flat lighting device using LED.

The lighting device includes: a light source unit 120 to which light sources, for example, LED light sources, are mounted in a printed circuit board; a diffusion plate 130 for diffusing light from the light source unit 120; and an optical plate 140 for concentrating the light emitted from the diffusion plate 130 within a predetermined range. The optical plate 140 is called an optical sheet because it has a sheet shape.

Also, the lighting device includes a first frame unit 110 and a second frame unit 150 for housing the light source unit 120, the diffusion plate 130 and the optical plate 140.

The diffusion plate 130 may be implemented as a sheet or a substrate for diffusing light. According to another exemplary embodiment, the diffusion plate may be implemented by bonding the sheet and the substrate. The diffusion plate 130 diffuses and emits the light incident through its one surface. The diffusion plate 130 reduces hot spots in which the light emitted from the light source unit 120 is concentrated and distributes uniformly the light. Generally, the diffusion plate 130 refracts the light in a direction in which a high UGR is generated, for example, up to an angle of about 60 degrees or more from a base line when the base line vertical to the diffusion plate 130 is set to 0 degrees, thereby causing glare to the eyes and making a user's eyes tired.

The light emitted from the diffusion plate 130 throughout a wide angle is incident to the optical plate 140. A divergence angle of the light emitted from the optical plate 140 has a narrower or smaller range than that of the light emitted through the diffusion plate 130. That is, the optical plate 140 functions to reduce the range of the divergence angle of the light which is incident through the diffusion plate 130.

The optical plate 140 may be implemented using a photo functional plate or sheet. In particular, the optical plate may be formed or manufactured using a plate on which micro pattern arrays (MLA) are patterned.

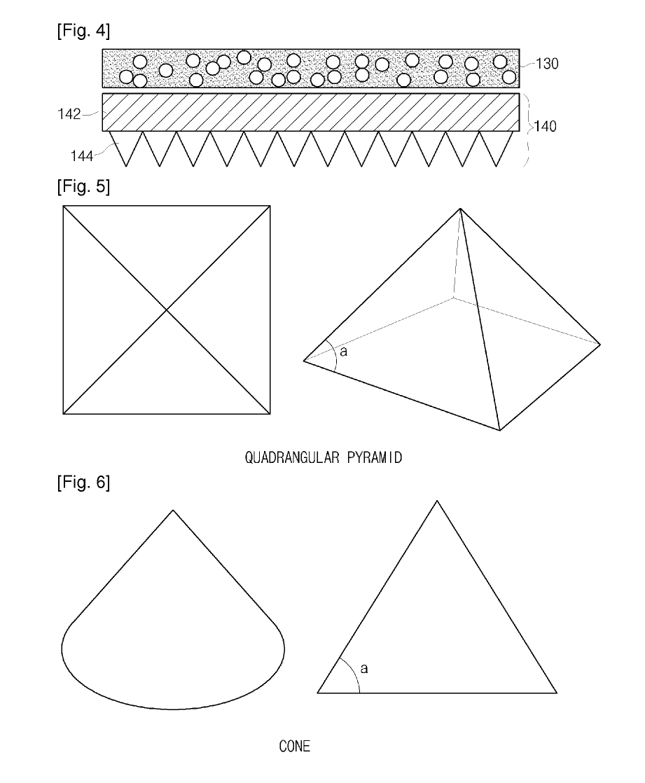

FIG. 4 is a view showing the enlarged diffusion plate 130 and optical plate of the flat lighting device of FIG. 3.

Referring to FIG. 4, the diffusion plate 130 may be implemented by a resin layer 132 including beads 134. That is, the diffusion plate 130 includes the resin layer 132 and the beads embedded in the resin layer 132. The beads 134 scatter the light incident to the diffusion plate 130. Basically, the optical plate 140 includes a plurality of micro pattern arrays 144 formed on the base plate 142. The micro pattern arrays may be formed on the base plate 142 formed of polycarbonate or polymethyl methacrylate (PMMA) by using resin.

That is, the optical plate 140 is formed by patterning the micro pattern arrays (MPA) on the base plate 142. The micro pattern arrays include a plurality of micro pattern units 144. The micro pattern units 144 have a shape such as a quadrangular pyramid, a cone, a polypyramid shape and the like.

FIG. 5 and FIG. 6 are views showing shapes of the micro pattern units 144 of the optical plate according to the other exemplary embodiments of the present invention. FIG. 5 illustrates the micro pattern units having a quadrangular shape. On the right side thereof, a view of the micro pattern units having the quadrangular shape when seen from an upper side is illustrated. On the left side thereof, a perspective view of the micro pattern units having the quadrangular shape is illustrated. Furthermore, FIG. 6 illustrates the micro pattern units having a conical shape. On the right side thereof, a perspective view of the micro pattern units having the conical shape is illustrated. On the left side thereof, a view for explaining the edge angle of a cone is illustrated.

The light incident to the optical plate 140 by the micro pattern units 144 is refracted toward a direction vertical to the optical plate 140, and the URG is reduced accordingly.

In this case, the distribution of light of the lighting device is changed depending on an angle a formed by each micro pattern unit with respect to the base plate 142. In the other words, the distribution of light of the lighting device is influenced by an edge angle of each micro pattern unit. Here, the edge angle of the micro pattern units means an angle formed between the base plate and a side surface of the micro pattern units and is as illustrated in FIG. 5 and FIG. 6. In this case, the edge angle is an angle formed in an inner part of the micro pattern units.

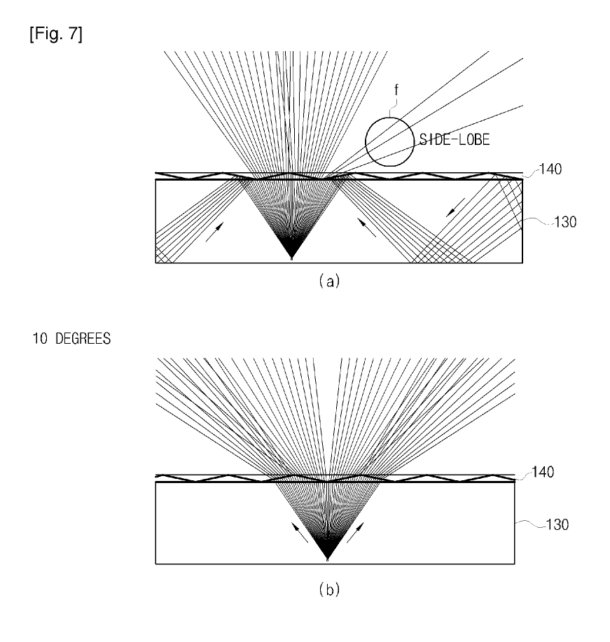

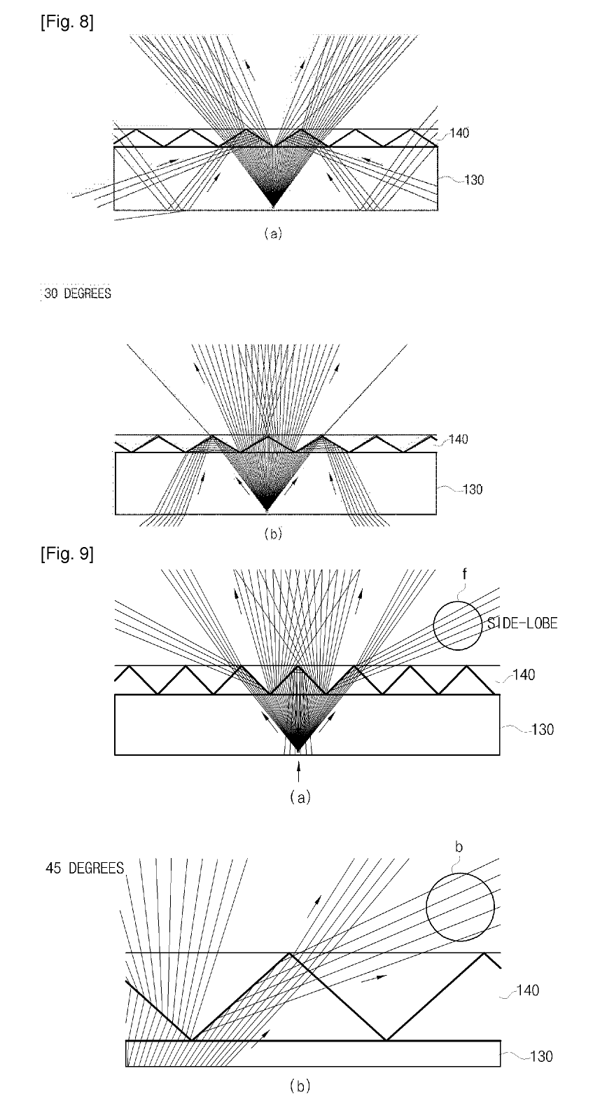

FIG. 7 through FIG. 9 illustrate the simulation results of light paths in the case where the micro pattern units have a quadrangular pyramid shape. FIG. 7 shows a light path in the case where an edge angle of the quadrangular pyramid is 10 degrees. FIG. 8 shows a light path in the case where an edge angle of the quadrangular pyramid is 30 degrees. FIG. 9 shows a light path in the case where an edge angle of the quadrangular pyramid is 45 degrees.

FIG. 7 shows a light path in the case where light is incident from the side surface of the micro pattern units having the quadrangular pyramid shape with the edge angle of 10 degrees. As illustrated therein, when the base line vertical to the diffusion plate 130 is set to 0 degrees, the light is emitted from the optical plate 140 even at a larger angle than an angle of about 60 degrees from the base line. This is indicated by reference numeral f in the drawing. This phenomenon is called a side-lobe. The side-lobe phenomenon brings glare to the eyes to a user, thereby making the user's eyes tired. That is, the lighting device including the micro pattern units shows that the UGR is a value of 19 or more.

FIG. 8 shows a light path in the case where light is incident from the side surface with respect to the micro pattern units having the quadrangular pyramid shape with the edge angle of 30 degrees. As illustrated therein, the light is irradiated from the optical plate 140 only at the angle of about 60 degrees or less from a base line. That is, at the larger angle than the angle of about 60 degrees with respect to the base line, the light is not almost emitted from the optical plate 140.

FIG. 9 shows a light path in the case where the light is incident from the side surface with respect to the micro pattern units having the quadrangular shape with the edge angle of 45 degrees. As illustrated therein, in the case of the micro pattern units having the quadrangular shape with the edge angle of 45 degrees, the side-lobe phenomenon in which the light is emitted from the optical plate 140 even at the larger angle than the angle of about 60 degrees from the base line is generated.

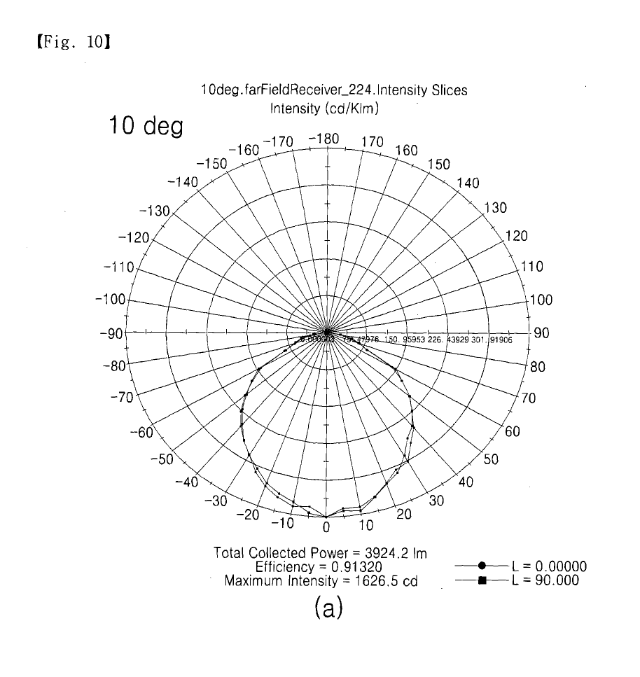

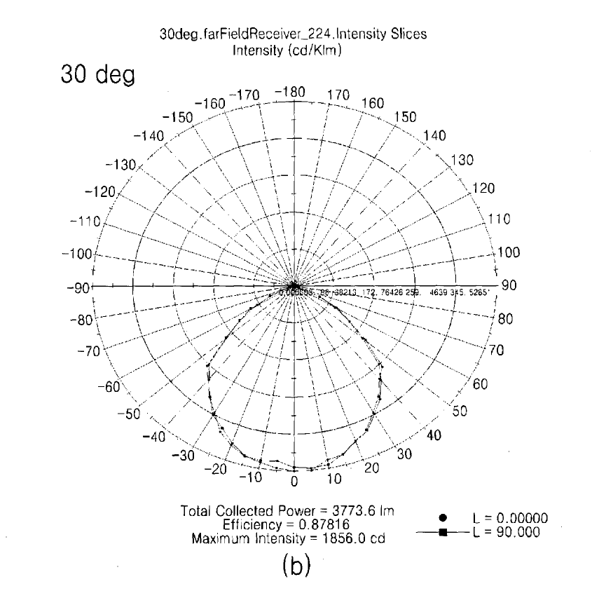

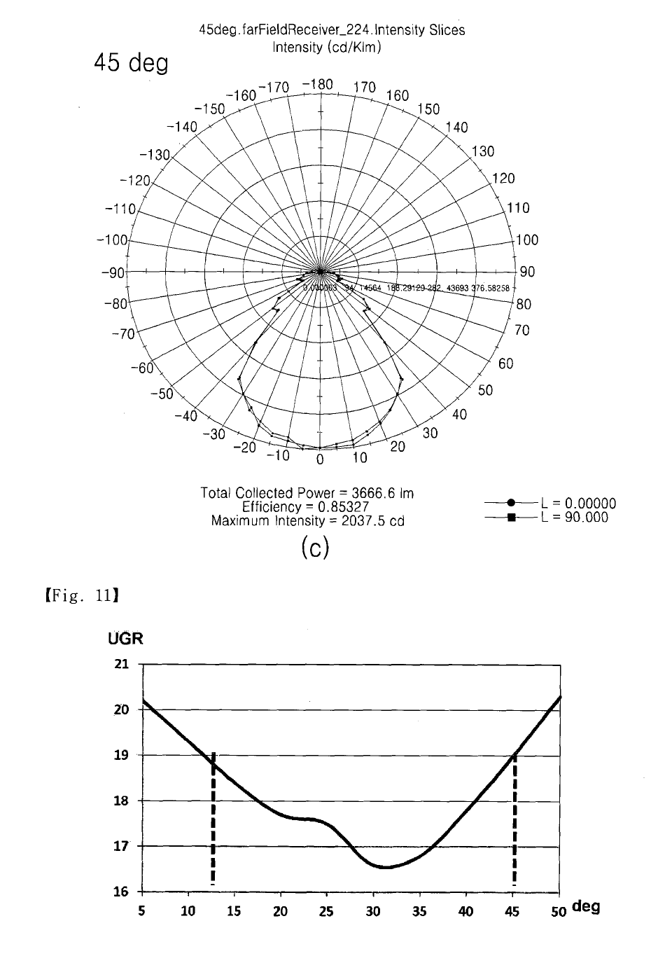

The distribution of light of the micro pattern units having the quadrangular shape is illustrated in FIG. 10.

Referring to FIG. 10, when the edge angles of the micro pattern units having the quadrangular shape are 10 degrees, 30 degrees and 45 degrees, respectively, the distributions of light are shown. When the base line vertical to the optical plate 130 is set to 0 degrees, a UGR value and a total luminous flux based on an edge angle of the quadrangular pyramid were measured. The distributions of light were measured at the same time as increasing the edge angle from about 5 degrees to 50 degrees, but only some part of them is illustrated in FIG. 5.

FIG. 11 to FIG. 13 are graphs showing optical properties based on the values of an edge angle of the micro pattern units having the quadrangular shape.

An x-axis on the graph of FIG. 11 shows the values of an edge angle of the micro pattern units having the quadrangular shape. A y-axis shows the UGR based on the edge angle of the quadrangular pyramid. As illustrated in FIG. 11, when the edge angle of the quadrangular pyramid ranges from about 13 degrees to 45 degrees, the UGR value shows 19 or less.

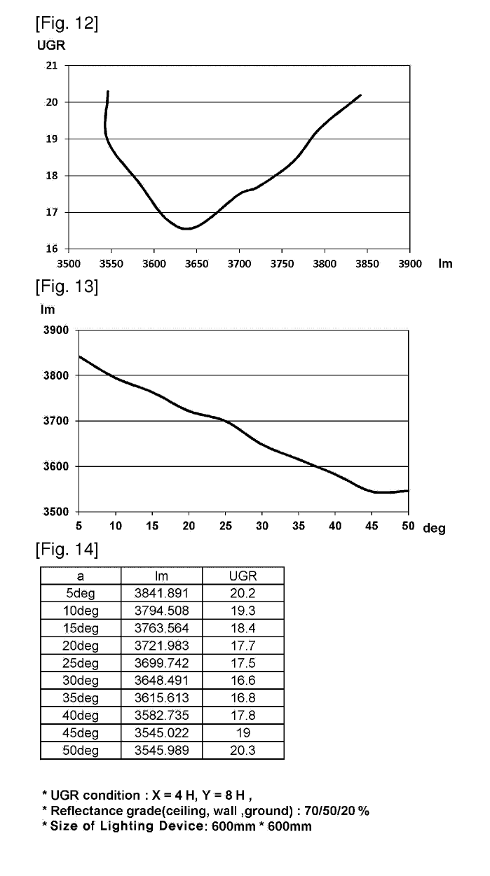

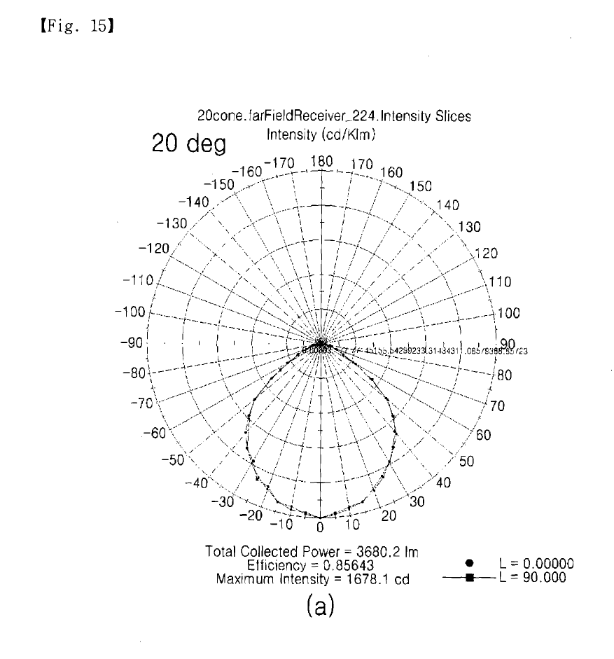

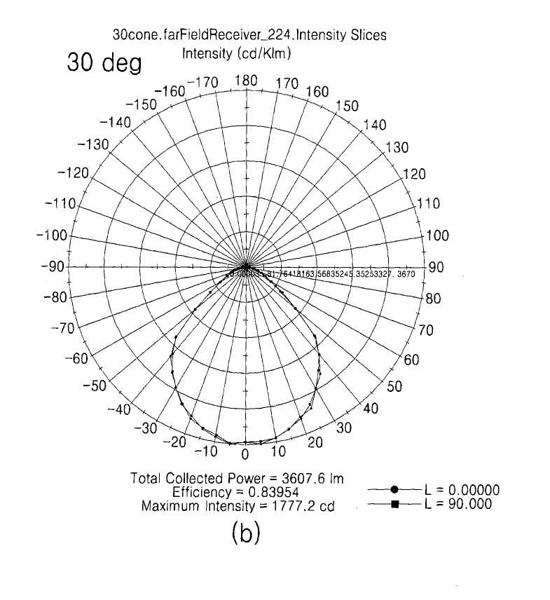

FIG. 12 shows a relation between the luminous flux and the UGR value, and FIG. 13 shows a relation between the quadrangular pyramid and the edge angle. Furthermore, FIG. 14 shows a relation between the edge angle of the quadrangular pyramid, the luminous flux, the UGR value as a table. As illustrated, when the luminous flux ranges from 3550 lm to 3800 lm, the UGR value shows 19 or less. As the edge angle of the quadrangular pyramid increases, the luminous flux lm reduces.

As illustrated in FIG. 10 to FIG. 14, the micro pattern units having the quadrangular pyramid shape shows a lowest UGR value at the angle of 30 degrees. Furthermore, when the edge angle of the quadrangular pyramid ranges from about 30 degrees to 35 degrees, it shows a lowest UGR value. As the edge angle of the micro pattern units reduces or increases from 30 degrees to 35 degrees, the distributions of light widen, and the UGR increases. In particular, in a range of the edge angle of 45 degrees or more, the side-lobe phenomenon is generated, thereby increasing the UGR value. In the case of the luminous flux (light efficiency), as the edge angle increases, the luminous flux reduces. This is because an amount of light which is recycled and returned depending on an increase in angle increases. As the edge angles of the quadrangular pyramid are adjusted, the UGR and efficiency can be controlled to be suitable for application fields.

Hereinafter, optical properties of the lighting device according to the edge angle of the micro pattern units having a conical shape will be explained.

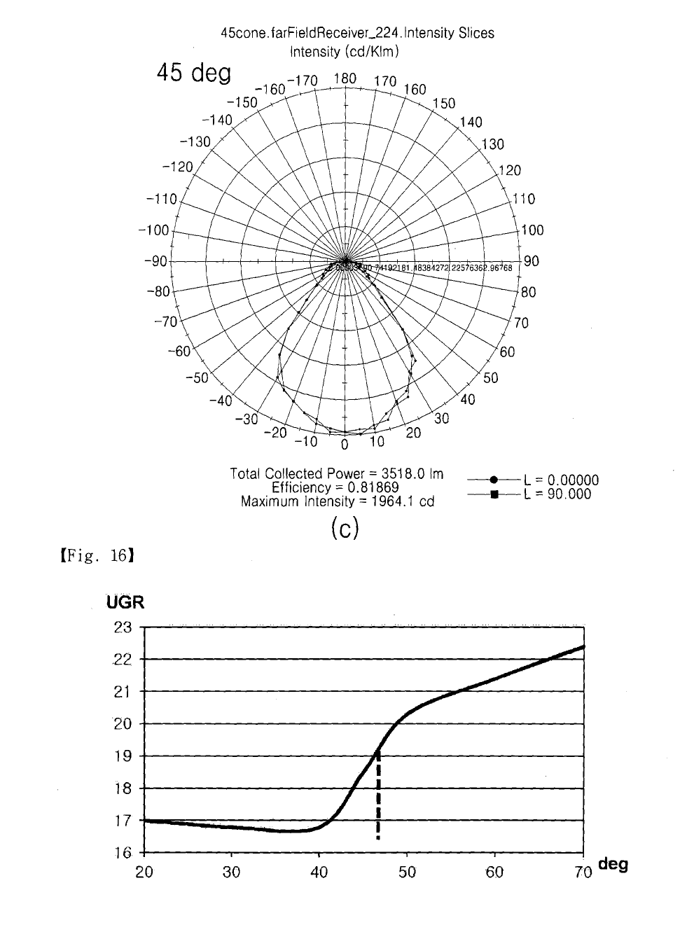

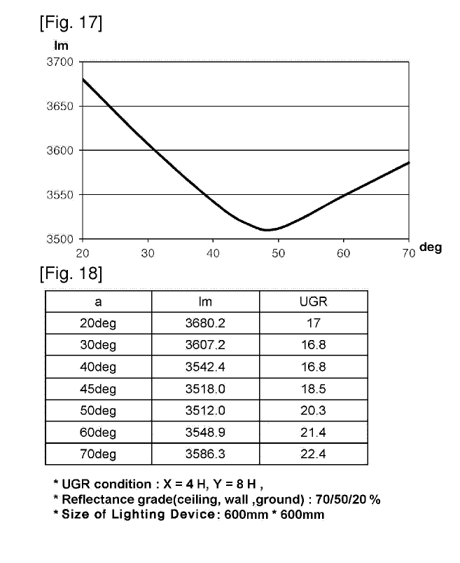

FIG. 15 shows the distribution of light of the micro pattern units having the conical shape. FIG. 16 through FIG. 18 are graphs showing the optical properties based on the edge angle of the micro pattern units having the conical shape. Furthermore, FIG. 8c is a relation between an edge angle of the cone, a luminous flux, a UGR as a table.

(a) through (c) of FIG. 15 show the distributions of light in the case where the edge angles of the micro pattern units having the conical shape are 20 degrees, 30 degrees and 45 degrees, respectively. When the base line vertical to the diffusion plate 130 is set to 0 degrees, the UGR value, and a total luminous flux based on the edge angle of the quadrangular pyramid were measured. The distributions of light were measured at the same time as increasing the edge angle from 10 degrees to 70 degrees, but FIG. 7 illustrates some part of them.

As illustrated in FIG. 15 to FIG. 18, in the case of the micro pattern units having the conical shape, when the edge angle ranges from 30 degrees to 40 degrees, a lowest UGR value is shown. At the edge angle of about 47 degrees or more, the UGR value of 19 or more is shown. Also, the luminous flux reduced as the edge angle of the cone increases from 20 degrees to about 48 degrees. Furthermore, when the edge angle is in a range of about 48 degrees or more, the luminous flux increased.

Like this, to be similar to the micro pattern units having the quadrangular shape, the micro pattern units having the conical shape show the lowest UGR value when the edge angle ranges from 30 degrees to 40 degrees. When the edge angle is in the range of 45 degrees or more, the side-lobe phenomenon is generated, thereby increasing the UGR value. In the case of a total luminous flux (light efficiency), it reduces as the edge angle increases.

Like this, the present invention provides the optical plate which functions to control the UGR (glare) in the flat lighting device. In the optical plate for lighting, the micro pattern (a triangular pyramid shape, a quadrangular pyramid shape, a polypyramid shape, and a conical shape) arrays are formed. Furthermore, the functions to control the UGR and to remove hot spots are provided by laminating and applying the diffusion plate and the micro pattern units. The present invention provides the optical plate for lighting which can adjust the UGR and efficiency (total luminous flux) by adjusting the shape of the micro pattern units. Specifically, the present invention may optimize the UGR and efficiency by changing the edge angle of the micro pattern units.

As previously described, in the detailed description of the invention, having described the detailed exemplary embodiments of the invention, it should be apparent that modifications and variations can be made by persons skilled without deviating from the spirit or scope of the invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims and their equivalents.

1. An optical sheet for a lighting device, comprising:
a base plate; and
a plurality of micro pattern units formed on the base plate,
wherein the respective micro pattern units have any one shape of a quadrangular pyramid shape, a conical shape, and a polypyramid shape; and
wherein an edge angle formed between the base plate and a side surface of the micro pattern units is determined within a range of 15 to 45 degrees.

2. The optical sheet of claim 1, wherein the plurality of micro pattern units form a micro pattern array.

3. The optical sheet of claim 1, wherein an edge angle formed between the base plate and a side of the micro pattern units is determined within a range of 30 to 40 degrees.

4. The optical sheet of claim 1, wherein the base plate is formed of polycarbonate (PC) or polymethyl methacrylate (PMMA).

5. The optical sheet of claim 1, wherein the plurality of micro pattern units are formed on the base plate using resin.

6. A lighting device, comprising:
a light source unit for emitting light;
a diffusion plate for diffusing and irradiating the light incident from the light source unit; and
an optical sheet including a base plate, and a plurality of micro pattern units formed on the base plate and configured to reduce an emission range of light emitted from the diffusion plate;
wherein the respective micro pattern units have any one shape of a quadrangular pyramid shape, a conical shape, and a polypyramid shape; and
wherein an edge angle formed between the base plate and a side of the micro pattern units is determined within a range of 15 to 45 degrees.

7. The lighting device of claim 6, wherein the plurality of micro pattern units form a micro pattern array.

8. The lighting device of claim 6, wherein an edge angle formed between the base plate and a side of the micro pattern units is determined within a range of 30 to 40 degrees.

9. The lighting device of claim 6, wherein the base plate is formed of polycarbonate (PC) or polymethyl methacrylate (PMMA).

10. The lighting device of claim 6, wherein the plurality of micro pattern units are formed on the base plate using resin.

11. The lighting device of claim 6, further comprising a frame unit for housing the light source unit, the diffusion plate and the optical sheet.

12. The lighting device of claim 6, wherein the diffusion plate comprises a resin layer and beads embedded in the resin layer.

13. The lighting device of claim 6, further comprising a frame unit configured to receive and protect the light source unit, the diffusion plate, and the optical sheet.
